(19) United States
(12) Patent Application Publication
(10) Pub. No.: US 2014/0164586 A1
(43) Pub. Date: Jun. 12, 2014

(54) OPPORTUNISTICALLY DELAYED OFFER AND REQUEST FULFILLMENT

(71) Applicant: VIASAT, INC., Carlsbad, CA (US)

(72) Inventors: Mark D. Dankberg, Encinitas, CA (US); Daniel M. Newman, Littleton, MA (US); James Esserman, La Jolla, CA (US); David Lerner, Newton, MA (US); Peter Lepeska, Boston, MA (US)

(73) Assignee: VIASAT, INC., Carlsbad, CA (US)

(21) Appl. No.: 13/734,584

(22) Filed: Jan. 4, 2013

Related U.S. Application Data
(60) Provisional application No. 61/736,448, filed on Dec. 12, 2012.

(51) Int. Cl. H04L 12/24

(52) U.S. Cl. CPC H04L 41/22
USPC 709/223

(57) ABSTRACT

Systems and methods are described for subscriber-driven resource shifting in an attempt to maximize delivery of requested content to subscribers while minimizing the impact of satisfying those requests to network infrastructure resources. For example, when a media plan subscriber requests access to media content under the media plan, a determination is made that the media can be delivered at an earlier timeframe for a particular cost or at a later timeframe for a lower cost. Accordingly, an offer is presented to the requesting subscriber either to receive the media in the earlier timeframe at a higher cost, or to receive the media at a later timeframe in exchange for a discount (e.g., watch now for $4.99 or in 24 hours for free). Embodiments further handle delayed delivery of the content, notification of the delayed delivery to the subscriber, accounting for the delayed delivery, and/or other related functions.

### FIELD

Embodiments relate generally to communications systems, and, more particularly, to content offer and request handling via communications systems.

### BACKGROUND

Users of communications services are increasingly accessing media content over data communications networks, like the Internet, through content service provider (e.g., media aggregator websites), web portals, games, and/or other user interfaces. Even television interfaces commonly include interactive electronic program guide interfaces that can facilitate access to linear, on-demand, and locally stored media content. Media content providers can use these interfaces and various marketing and incentive techniques to help users find and access desirable content, thereby increasing profitability, advertising opportunities, etc.

This increasing demand for media content also yields an increased demand for bandwidth resources of the underlying communications infrastructures. In some cases, communications service providers attempt to combat ever-increasing demands on their networks through increased prices, resource throttling, limitations on service offerings, etc. However, it can be preferable in other cases to better utilize available resources to satisfy the increasing demands. For example, bandwidth resources can often be more fully utilized through time- and/or demand-shifting techniques.

### BRIEF SUMMARY

Among other things, systems and methods are described for subscriber-driven resource shifting in an attempt to maximize delivery of requested content to subscribers while minimizing the impact of satisfying those requests to network infrastructure resources. Embodiments operate in the context of subscribers to a media plan that provides subscribers with access to media content according to a data allowance policy (DAP). When a subscriber requests access to media content (e.g., a movie) under the media plan, a determination can be made that the media can be delivered at an earlier timeframe (e.g., now) for a particular cost or at a later timeframe (e.g., in 24 hours) at a lower cost. For example, it is determined that the requested media could likely be delivered to the subscriber at a later time with an appreciably reduced impact to infrastructure resources. Accordingly, an offer is presented to the requesting subscriber to forego receiving (e.g., watch, download, etc.) the media in the earlier timeframe at a higher cost (e.g., a monetary cost, a cost to the subscriber's DAP, etc.); and, instead, to choose to receive the media at a later timeframe in exchange for a discount (e.g., at a reduced monetary cost, at a reduced cost to the subscriber's DAP, etc.). For example, the subscriber can opt to watch a movie now for a two-Gigabyte hit to the subscriber's DAP or in 24 hours for a zero-Gigabyte hit to the subscriber's DAP. Similarly, the subscriber can opt to watch a movie now for $4.99 or in 24 hours for free. Embodiments deliver the expressly delayed content within the later timeframe (e.g., using opportunistic techniques). Some embodiments further handle notification of the delayed delivery to the subscriber, accounting for the delayed delivery, and/or other related functions.

According to one set of embodiments, a method is provided for resource shifting in a communications infrastructure that provides sharing of a communications link over which a subscriber-side system is in communication with a provider-side system. The method includes: generating, by the subscriber-side system, a graphical user interface (GUI) for display to a user via a customer premises device through which a number of content objects is offered in association with a media plan; indicating to the user, by the subscriber-side system via the GUI in association with a content object of the content objects, a prompt providing user selection between delivery of the content object during an earlier timeframe at a higher cost and delivery of the content object during a later timeframe at a lower cost; receiving, by the subscriber-side system via the GUI, a local request in response to the prompt indicating that the user opts for delivery of the content object during the later timeframe at the lower cost; and communicating, by the subscriber-side system to the provider-side system over the communications link in response to receiving the local request, a remote request indicating that the user opts for delivery of the content object during the later timeframe.

According to another set of embodiments, a subscriber-side system is provided in communication with a provider-side system via a communications link of a communications infrastructure that provides resource sharing of the communications link. The subscriber-side system includes a customer premises device and a subscriber optimizer. The customer premises device is operable to: display a graphical user interface (GUI) to a user through which a number of content objects are offered in association with a media plan; and display a prompt via the GUI that provides user selection between delivery of the content object during a first timeframe at a first cost and delivery of the content object during a second timeframe at a second cost, the first timeframe ending sooner than the second timeframe with respect to a time at which the prompt is displayed, and the first cost being higher than the second cost. The subscriber optimizer is in communication with the customer premises device and is operable to: receive a local request in response to the prompt indicating that the user opts for delivery of the content object during the second timeframe at the second cost; and communicate to the provider-side system over the communications link, in response to receiving the local request, a remote request indicating that the user opts for delivery of the content object during the second timeframe.

According to another set of embodiments, another method is provided for resource shifting in a communications infrastructure that provides sharing of a communications link when communicating with a number of subscribers via their respective subscriber terminals. The method includes: receiving, by a provider-side system of the communications infrastructure, a request for a content object from a requesting subscriber via the communications infrastructure; offering the requesting subscriber a discount in exchange for the requesting subscriber opting for delayed delivery of the content object; and communicating the content object to the requesting subscriber in an opportunistically delayed manner via the communications infrastructure in response to determining that the requesting subscriber opted for delayed delivery of the content object.

According to another set of embodiments, a provider-side system is provided in a communications infrastructure that facilitates resource sharing of a communications link between the provider-side system and a number of subscribers via their respective subscriber terminals. The provider-side system includes a request handling subsystem and a communications subsystem. The request handling subsystem is operable to: receive a request for a content object from a requesting subscriber via the communications infrastructure; and determine whether the requesting subscriber opted for delayed delivery of the content object. The communications subsystem is in communication with the request handling subsystem and is operable to: communicate an offer to the requesting subscriber comprising a discount in exchange for the requesting subscriber opting for delayed delivery of the content object; and communicate the content object to the requesting subscriber in an opportunistically delayed manner via the communications infrastructure in response to determining that the requesting subscriber opted for delayed delivery of the content object.

### BRIEF DESCRIPTION OF THE DRAWINGS

The present disclosure is described in conjunction with the appended figures:

FIG. 1 shows a block diagram of an embodiment of a communications system having a provider system in communication with multiple subscriber systems over a communications link, according to various embodiments;

FIG. 2 shows a screenshot of an illustrative media aggregator webpage with certain media plan functionality to provide context for various embodiments;

FIGS. 3A and 3B show respective versions of the website of FIG. 2 after an interaction is detected between the subscriber and a plan media icon;

FIG. 4 shows a simplified block diagram of an illustrative communications architecture in which a provider system is in communication with content sources and subscriber systems, according to various embodiments;

FIG. 5 shows an illustrative computational system for implementing functionality of a subscriber optimizer, according to various embodiments;

FIG. 6 shows an illustrative computational system for implementing functionality of a provider optimizer, according to various embodiments;

FIG. 7 shows a flow diagram of an illustrative method for subscriber-driven resource shifting from the perspective of a subscriber-side system, according to various embodiments; and

FIG. 8 shows a flow diagram of another illustrative method for subscriber-driven resource shifting from the perspective of a subscriber-side system, according to various embodiments.

In the appended figures, similar components and/or features can have the same reference label. Further, various components of the same type can be distinguished by following the reference label by a second label that distinguishes among the similar components. If only the first reference label is used in the specification, the description is applicable to any one of the similar components having the same first reference label irrespective of the second reference label.

### DETAILED DESCRIPTION

Users of communications services are desiring more access to media content over data communications networks, like the Internet. New interfaces are making the media content easier to find and access, and new devices (including the proliferation of smart mobile devices) are increasing the opportunities for users to access and view high-quality media content throughout the day. These trends have caused rapid increases in demand for bandwidth resources of underlying communications infrastructures. Accordingly, providers of communications services are often seeking to maximize fulfillment of their customers' media demands without overloading their networks.

Embodiments operate in the context of a media plan, through which subscribers are provided access to media content over a data communications infrastructure. Subscribers' usage of the media plan is governed by a data allowance policy (DAP) that can provide various details and/or policies concerning how much data (e.g., bandwidth, storage, etc.) is allowed to the subscriber, the cost of that data, restrictions on usage of that data, etc. When a subscriber requests access to particular media object (e.g., a movie), predictions are made regarding how delivering the requested content to the subscriber would impact the subscriber's DAP, currently available (and already scheduled and/or or promised) infrastructure resources, and/or other concerns. From those predictions, it is determined that the requested media could likely be delivered to the subscriber at a later time with an appreciably reduced impact to infrastructure resources.

Accordingly, embodiments provide an offer to the subscriber (e.g., via an interface of a subscriber's television, computer, mobile device, or other customer premises device) through which the subscriber can opt to receive the content sooner for a first debit to the DAP or later for a second (reduced) debit to the DAP. For example, when the subscriber requests to watch a movie through a content aggregator's website, the subscriber is presented with an offer to either watch the movie now for a two-Gigabyte hit to the subscriber's DAP or in 24 hours for a zero-Gigabyte hit to the subscriber's DAP. Each explicitly delayed content request can be intelligently scheduled (e.g., prioritized, queued, etc.) for delivery within the promised delayed timeframe. In some embodiments, the intelligent scheduling exploits time- and/or demand-shifting opportunities, such as opportunistically available bandwidth, multicasting opportunities, etc. to effectively fulfill more content requests with an appreciably smaller impact to infrastructure resources.

As used herein, the term DAP is intended broadly to include any type of policy or the like that governs a subscriber's usage of data as part of a subscription data service. In one example, the DAP provides a usage allowance per month (e.g., in exchange for a monthly subscription charge). Some DAPs are set up so that certain types of data usage falls outside the DAP. For example, the DAP does not apply to usage of certain data types (e.g., email) and/or usage during certain times of day (e.g., outside of peak hours). Other DAPs include different allowances, for example, for different types of data (e.g., streaming media has a first associated allowance, and non-real-time file transfers have a second associated allowance), different times of day, etc. The DAP can provide fixed, variable, dynamic, and/or any other suitable types of data allowances. Further, the allowance can be expressed in any suitable manner. For example, the allowance can be expressed in terms of bandwidth (e.g., a number of bytes of communications bandwidth, storage bandwidth, etc.), pricing (e.g., dollars, credits, and/or the like for media and/or other objects), number of objects (e.g., a number of movies, etc.), etc.

As described above, embodiments offer delayed delivery of content in exchange for a reduced debit to the DAP. As used herein, terms like “debit,” “hit,” “cost,” and the like are intended generally to include any suitable positive or negative impact to the subscriber that can be exchanged for opportunistically delayed delivery of requested content. For example, delivering content to a subscriber at the time it is requested (i.e., without appreciable delay) carries a particular “base cost” (or hit or debit). This can be a base price (e.g., amount of money), a base deduction from the subscriber's monthly data allowance, etc. In exchange for opportunistically delaying delivery of the content, the subscriber can be offered the content at a lower price, at a reduced (or zero) deduction from the subscriber's monthly data allowance, etc. Additionally or alternatively, the exchange can include a reduction in future bandwidth throttling associated with the subscriber, credits to the subscriber for future content requests, a reduction in ads associated with viewing the content, a change in rights management options associated with the content, additional access to promotional materials, and/or any suitable type of exchange.

In the following description, numerous specific details are set forth to provide a thorough understanding of various embodiments. However, one having ordinary skill in the art should recognize that the invention can be practiced without these specific details. In some instances, circuits, structures, and techniques have not been shown in detail to avoid obscuring the present invention. Further, terms such as “optimize” or “maximize” are intended to connote a relative or desired outcome, rather than an absolute outcome, and should not be considered as limiting potential embodiments. For example, embodiments described with reference to optimization are intended to include even variations deemed to be sub-optimal. Further, a number of “opportunistic” techniques are described herein, and are intended broadly to include techniques for dynamically optimizing infrastructure resources based on present usage of those resources, for example, using opportunistic time shifting and/or opportunistic delay shifting techniques.

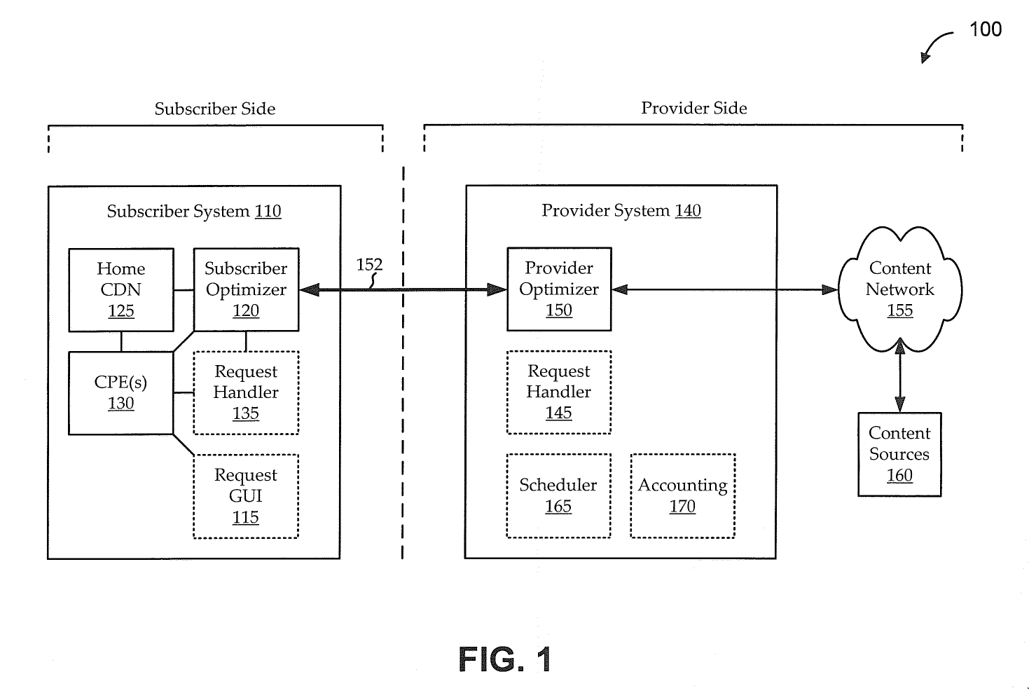

Turning first to FIG. 1, a block diagram is shown of an embodiment of a communications system 100 having a provider system 140 in communication with multiple subscriber systems 110 (only a single subscriber system 110 is shown) over a communications link 152. The communications link 152 can include one or more of any suitable type of communications link and can be part of one or more of any suitable type of network, including, for example, leased high-bandwidth lines (e.g., raw Ethernet), virtual private large-area network services (VPLS), Internet protocol virtual private networks (IP VPN), or other types of public or private, wired or wireless networks.

Some functionality exploits resource sharing over multiple communications links 152. Certain network architectures allow bandwidth resources to be shared through multicasting (e.g., including multicasting, point-to-multipoint, broadcasting, etc.) and/or other techniques. In one illustrative implementation, the communications system 100 is a satellite communications network with a provider system 140 (e.g., in a gateway or core node) in communication with subscriber terminals of subscriber systems 110 over satellite communications links (e.g., via carriers of spot beams of one or more satellites). For example, each communications link 152 includes one or more antennas, satellites, etc. As communications are essentially broadcast from the satellite to the subscriber terminals, multicasting techniques can be used to communicate content once for receipt by multiple subscribers concurrently. Similar techniques can be used with certain other wireless communications link architectures. Some other wired infrastructures can also use similar techniques in shared portions of the network. For example, a cable network can be architected to have a shared pipe between a cable head-end and an intermediate node (e.g., a neighborhood aggregator), at which node the shared pipe splits into individual pipes (e.g., to each household). Resources of the shared pipe can often be shared using similar techniques to those described above.

Some embodiments are described herein with respect to downstream traffic and sharing of forward link bandwidth resources. Similar techniques can also be applied with respect to upstream traffic and/or sharing of return link resources. For example, certain media upload contexts, including peer-to-peer implementations, can exploit functionality described herein in a manner that shares return link bandwidth resources.

The provider system 140 is further in communication with one or more content sources 160 via one or more content networks 155. The content sources 160 can include content servers and/or other suitable sources. Further, the content networks 155 are intended generally to include any suitable public or private, wired or wireless (e.g., short-range or long range, cellular, satellite, etc.) network components, nodes, or networks used to deliver content to subscriber systems 110 via provider systems 140. While the content sources 160 and content networks 155 are shown as separate from the provider system 140, they can be implemented in any suitable manner, including as part of the provider system 140. Some functionality described herein relates to provision of media content, such as movies, over the communications system 100. Accordingly, at least some of the content sources 160 are assumed to be sources of media content objects. For example, a content source 160 can be a content service provider website that provides users with access to movies, music, and/or other media over the Internet via their respective subscriber system 110 and provider system 140.

Various types of functionality are described herein relating to communications between the provider system 140 on a provider side of the communications system 100 infrastructure and the one or more subscriber systems 110 on a subscriber side of the communications system 100 infrastructure. In some implementations, the provider system 140 acts substantially as a server and the subscriber system 110 acts substantially as a client, and communications between the systems over the communications link 152 can be considered client-server communications over a client-server link. Accordingly, provider-side functions can be implemented as functions of server-side systems or components, service provider systems or components, gateways, head-ends, or the like without departing from embodiments. Similarly, subscriber-side functions can be implemented as functions of user-side systems or components, client-side systems or components, customer premises devices, subscriber modems, subscriber devices, or the like without departing from the scope of embodiments.

In some cases, various functions described herein are only available to subscribers of certain services from a service provider, such as subscribers to a media plan. The service provider can own and/or control some or all of the components that facilitate the functionality, such as the provider system 140. In some embodiments, the service provider also owns some or all of the content sources 160, subscriber systems 110, infrastructure components, etc. For example, a service provider offers certain functionality to subscribers by virtue of relationships with content providers, relationships with subscribers, ownership or control of provider-side systems, and ownership or control of certain subscriber-side devices.

In some instances, a single subscriber is associated with subscription services, and any subscriber-side devices used with those services are associated with that subscriber. In other instances, a single subscriber is associated with subscription services, but the subscriber can access services nomadically or otherwise, including through devices that are not associated with that subscriber (e.g., by logging in to a service, etc.). In still other instances, one or more subscribers are associated with subscription, but the media services can be accessed by additional users. For example, a subscriber can own a television through which subscription media services can be accessed by anyone in the house, including non-subscriber members of the household, guests, etc. In even other instances, one or more human or machine agents are associated with the subscriber and can interface with services on the subscriber's behalf. For example, a smart device disposed in the subscriber's network (e.g., integrated in or in line with the subscriber's modem, set-top box, etc.) can monitor user behavior and/or use other information to make smart requests for content on behalf of the subscriber. In some implementations, these smart requests are considered by the provider just as any other explicit request by the subscriber. Accordingly, while certain functionality can be governed by (e.g., handled according to) a relationship between the subscriber and the provider, it is not always the subscriber (or a particular subscriber-associated device) that is interacting with, exploiting, and/or facilitating those services. Embodiments are intended generally to operate in and account for any of those scenarios, even though, for the sake of simplicity, embodiments are described with reference to the subscriber making content requests, interacting with subscription services via devices and interfaces, etc.

Further, various embodiments are described with reference to a “requesting” or “non-requesting” subscriber, or the like. These types of designations are intended only to suggest a particular user's role for a particular transaction. The same user can be a non-requesting user in one transaction and the requesting user in a different transaction (e.g., at the same or different times). Even further, though only a single requester is shown for the sake of simplicity, a single transaction can involve multiple requesters, and/or multiple transactions can be processed concurrently such that the network includes many concurrent requesting and non-requesting users. For example, when a subscriber requests content, the content can end up being multicast to the requesting subscriber and one or more non-requesting subscribers. Similarly, as will be described below, a requesting subscriber can opt to delay receipt of content, and can ultimately receive some or all of the content as part of multicast fulfillment of a request of another requesting subscriber.

As will be described more fully below, embodiments of the subscriber systems 110 are configured to perform various types of functionality using a subscriber optimizer 120. For example, the subscriber optimizer 120 can help manage content requests from subscribers and content delivery to subscribers via subscriber devices. In some implementations, the subscriber optimizer 120 is in communication with the provider optimizer 150 of the provider system 140 in such a way as to effectuate advanced optimization functions. For the sake of simplicity, certain client-server types of functionality can be referred to as involving communications over a virtual (or logical) communications link 152, though this “link” can, in fact, include a number of physical links from one or more communications infrastructures. For example, the subscriber optimizer 120 and the provider optimizer 150 can act as a proxy client and a proxy server, respectively, in communication over a proxy tunnel that facilitates acceleration, optimization, and other functionality.

In some embodiments, the subscriber systems 110 include one or more customer premises devices (e.g., set-top boxes, televisions, home network devices, etc.), referred to as “customer premises equipment” or “CPE” 130. At least one CPE 130 is assumed to provide a user interface functionality through which a subscriber can interact with service provisions. Embodiments are also configured to implement a home content distribution network (CDN) 125. The home CDN 125 can include any useful types of storage and/or networking components. For example, embodiments of the home CDN 125 can include a single storage device (e.g., a server or disk drive), distributed local storage (e.g., a RAID array, set of servers, etc.), networked storage (e.g., using a local area network, a storage area network, “cloud” storage, or the like), etc. Various embodiments of the subscriber optimizer 120 are configured to manage (e.g., direct, monitor, etc.) functions of the CPE(s) 130, the home CDN 125, communications among those components, communications between those components and other nodes of the communications system 100, etc.

For added clarity, various functional subsystems are shown as dashed boxes. These functional subsystems can be implemented by any suitable system, subsystem, or component shown or by others not shown. Embodiments of the subscriber system 110 include a request handler subsystem 135 and a request graphical user interface (GUI) subsystem 115. In some implementations, the request handler subsystem 135 is a functional subsystem of the subscriber optimizer 120, and the request GUI subsystem 115 is a functional subsystem of one or more CPEs 130. Embodiments of the provider system 140 include a request handler subsystem 145, a scheduler subsystem 165, and an accounting subsystem 170. In some implementations, each is a functional subsystem of the provider optimizer 150.

For example, a subscriber is viewing a website on a web-enabled CPE 130 that displays a number of media content offerings using functionality of the request GUI subsystem 115. When the subscriber selects one of the offerings, the request GUI subsystem 115 passes relevant information to the request handler subsystem 135 of the subscriber optimizer 120 (e.g., in a subscriber modem, another CPE 130, etc.). The request handler subsystem 135 of the subscriber optimizer 120 communicates the request to the request handler subsystem 145 of the provider optimizer 150 in the provider system 140. Functionality of the scheduler subsystem 165 and the account management subsystem 170 can be used to determine whether and/or when to communicate the requested content to the subscriber (e.g., whether now or delayed, etc.), how to communicate the content (e.g., whether to multicast, which coding and/or modulation scheme to apply, which carriers and/or spot beams to use, etc.), how much to charge for the content, etc.

In one illustrative scenario, the subscriber system 110 includes a CPE 130 operable to display a GUI to the subscriber, showing a number of media offerings in association with a media plan. For example, the CPE 130 is a web-enabled device displaying, through a browser interface, a content aggregator website including movie selections for viewing from the Internet. The GUI can be handled by the request GUI subsystem 115. When the subscriber selects one of the movies (e.g., by clicking on a movie icon, “mousing over” the movie icon, etc.), the request GUI subsystem 115 sends relevant information to the request handler subsystem 135 of the subscriber optimizer 120 for processing. Embodiments perform various functions to determine what resources will be involved in delivering the requested movie to the requesting subscriber and whether those resources are available (and/or when those resources are expected to become available).

Based on the resource and availability determinations, a prompt is displayed to the subscriber via the GUI of the CPE 130. The prompt can be represented by any suitable interactive element, such as a button, link, voice prompt, gesture prompt, etc. Through the prompt, the subscriber can interactively opt for delivery of the movie either during an earlier timeframe at a higher cost or during a later timeframe at a lower cost. According to one example, the prompt indicates that the subscriber can watch the movie now (e.g., via substantially real-time streaming, via substantially immediate downloading, etc.) for a particular price, or the subscriber can wait some amount of time (e.g., 24 hours) to watch the movie for free. If the subscriber opts for delayed delivery, the movie can be delivered, for example, to the subscriber's home CDN 125 during a time when the network has excess available bandwidth, as multicast data while the movie is being communicated to another subscriber that opted to watch now, etc. According to another example, the prompt indicates that the subscriber can watch the movie now for a 4-Megabyte debit to the subscriber's monthly usage allowance (e.g., according to the subscriber's DAP), the subscriber can wait 12 hours in exchange for the movie only counting as a 2-Megabyte debit to the subscriber's monthly usage allowance, or the subscriber can wait 36 hours in exchange for the movie not counting at all against the subscriber's monthly usage allowance.

Many types of offers can be provided in exchange for the subscriber waiting. In some implementations, the offers are the same for all content that is part of the media plan. For example, all media plan movies are available now for a hit to the subscriber's DAP that is comparable to the size of the movie or in 24 hours for free. In other implementations, the offers are dynamically generated for some or all content that is part of the media plan, according to resource availability. In one illustrative example, a subscriber selects a movie. If the movie is already in the subscriber's home CDN 125 (and the subscriber has rights to view the movie), the movie can be made available for viewing now at no cost. If the movie is not already in the subscriber's home CDN 125 the movie can be made available to be watched now for a predetermined hit to the subscriber's DAP (e.g., an amount of data usage, an amount of money, etc.). If the movie is not already in the subscriber's home CDN 125 (or is only partially available in the home CDN 125), and there is sufficient excess bandwidth presently available on the network to satisfy the request, the movie can be made available to be watched now for free or for a reduced hit to the subscriber's DAP. If the movie is not already in the subscriber's home CDN 125 (or is only partially available in the home CDN 125), and there is insufficient excess bandwidth presently available on the network to satisfy the request, the movie can be made available to be watched at a later timeframe for free or for a reduced hit to the subscriber's DAP. Other scenarios or implementations can result in some or all of these and/or other options being provided to the subscriber.

In some embodiments, the determination of which options are available and/or which options to provide to the subscriber is made by the subscriber optimizer 120. The subscriber optimizer 120 can be aware of (or can query) the contents of the home CDN, presently available network resources, and/or any other useful information in making the determination. For example, the subscriber responds to the prompt via the CPE 130 (e.g., via the request GUI subsystem), which communicates the response to the subscriber optimizer 120 for handling (e.g., using its request handler subsystem 135). In other embodiments, the determination of which options are available and/or which options to provide to the subscriber is made by the provider optimizer 150. The provider optimizer 150 can be aware of (e.g., can maintain a dictionary or model of) the contents of the home CDN, presently available network resources, and/or any other useful information in making the determination. For example, the subscriber responds to the prompt via the CPE 130, which communicates the response to the subscriber optimizer 120. The subscriber optimizer 120 communicates a query to the provider optimizer 150 to determine when the content object can be provided to the user. The provider optimizer 150 returns an indication to the subscriber optimizer 120, in response to the query, that the content object can be provided to the user during at least the earlier timeframe at the higher cost and during the later timeframe at the lower cost. For example, the provider optimizer 150 determines that the requested object is the type of object, and the resource availability is such, that the object can be offered in either timeframe at different costs. The CPE 125 then displays the prompt according to the indication.

The subscriber can respond to the prompt, thereby indicating whether the subscriber opts for delivery of the movie at the earlier timeframe (e.g., now) at the higher cost or during the later timeframe at the lower cost. For example, the subscriber can use a mouse or other pointer device, a remote control, voice commands, or any other suitable interaction. In some embodiments, the subscriber optimizer 120 receives the subscriber's option, and communicates the option to the provider optimizer 150 over the communications link 152. If the subscriber opted to delay delivery of the requested content, the subscriber system 110 can receive an opportunistically delayed communication of the requested content object from the provider system 140 during the later timeframe.

In some embodiments, the delayed delivery is opportunistic, so that time- and/or demand shifting opportunities are exploited to maximize delivery of requested media to subscribers while minimizing the impact to network resources. Because these opportunities can arise in unpredictable ways, it is generally not possible, practical, or desirable to estimate exactly when delayed delivery will occur. Accordingly, in some implementations, the estimated delivery time is intended to be an upper limit, and the subscriber can actually receive the requested media prior to that estimated delivery time in many or most cases. Embodiments of the subscriber optimizer 120 notify the subscriber when the requested media has been delivered (e.g., is available in the home CDN for watching).

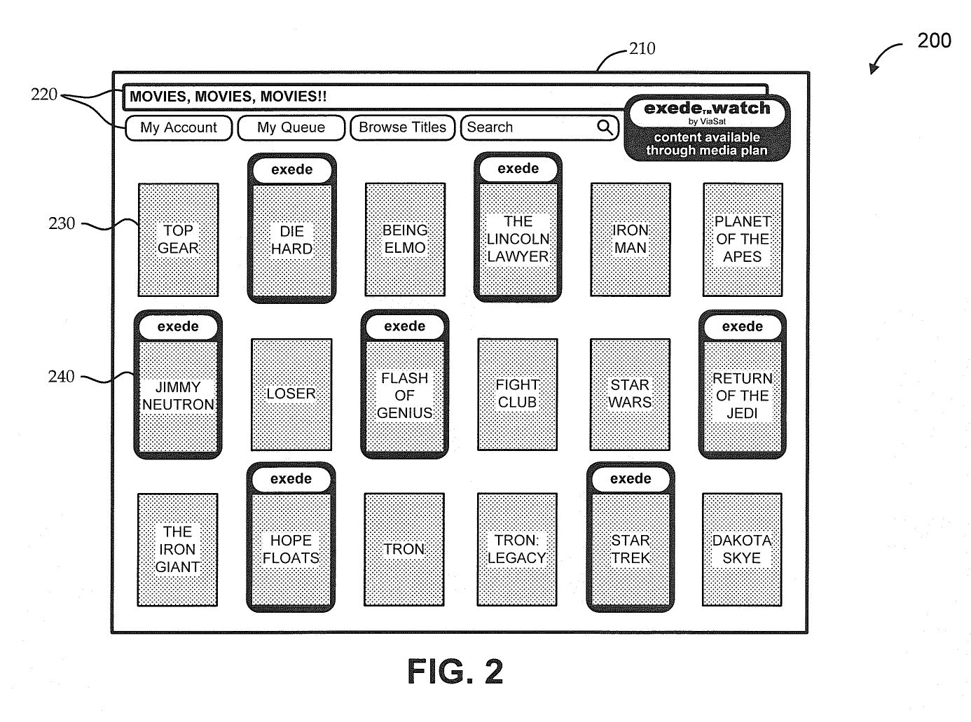

FIG. 2 shows a screenshot 200 of an illustrative media aggregator webpage 210 with certain media plan functionality to provide context for various embodiments. The webpage 210 includes a number of GUI elements 220, like title bars, navigation buttons, and the like. The webpage 210 also includes a number of icons corresponding to media being offered through the aggregator's site.

For the sake of describing FIG. 2, a scenario is assumed in which the webpage 210 is being accessed by a subscriber to a media plan (illustrated as “exede™watch”), which gives the subscriber a data allowance policy (DAP) that includes a certain usage allowance per month (e.g., a certain number of Megabytes that can be used by the subscriber per month). While the subscriber can use the data allowance to access any media (e.g., subject to terms and conditions and/or other policies), the media plan includes features to help the subscriber maximize access to desired media while minimizing the hit to the subscriber's DAP. For example, certain content can be offered with enhanced options under the media plan.

In some implementations, all displayed media options are available as part of the media plan. In other implementations, only a subset of the media is part of the media plan. As illustrated, some icons indicate non-plan media 230, while other icons indicate plan media 240 (e.g., “exede” media). According to the assumed scenario, the subscriber can always access any of the offered media (i.e., any non-plan media 230 or plan media 240) at a cost to the subscriber's DAP. When accessing plan media 240, however, additional options are provided that allow the subscriber to watch the media at a later timeframe for a reduced cost to the DAP.

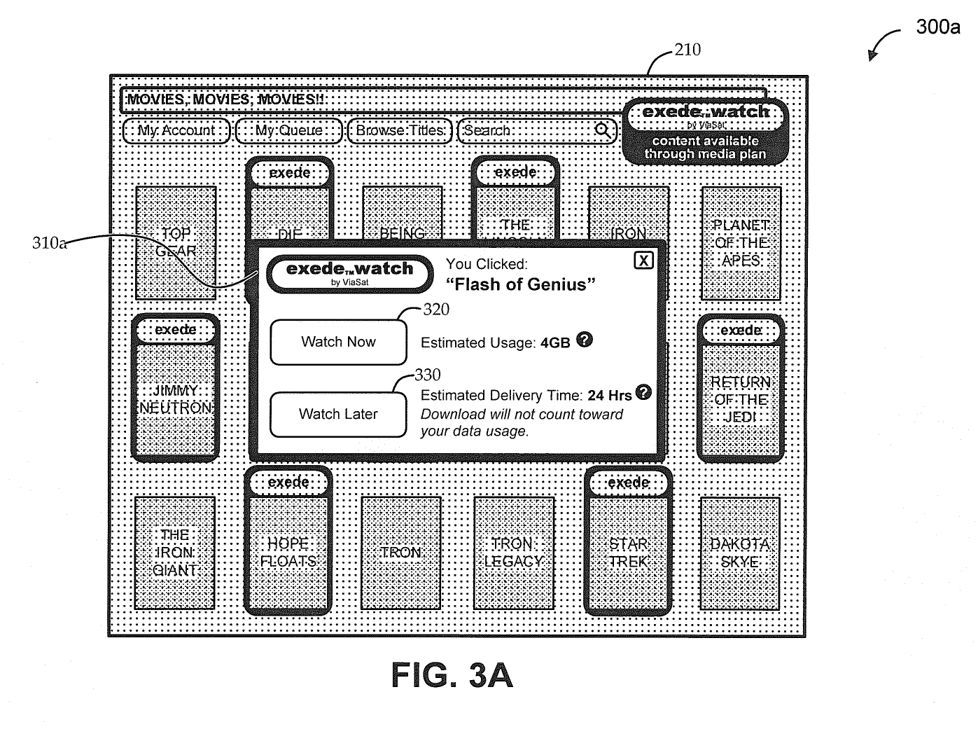

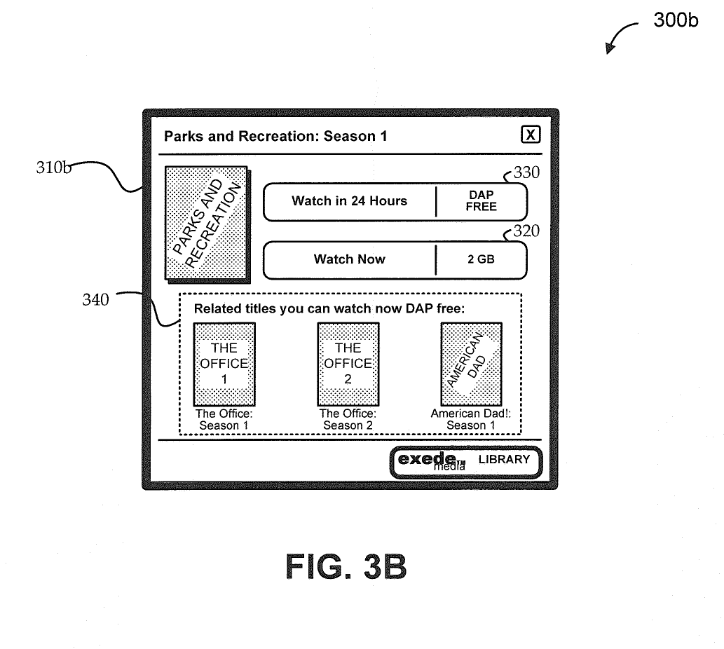

Turning to FIG. 3A, the website 210 of FIG. 2 is shown after an interaction is detected between the subscriber and a plan media 240 icon (e.g., by a mouse click, mouse over, remote control selection, or the like). Continuing the assumed scenario described in context of FIG. 2, the subscriber clicks on the movie “Flash of Genius,” which is indicated as plan media 240 (illustrated with an “exede” box around the movie icon in FIG. 2). In response to the selection, a new GUI element appears as a pop-up 310a. The pop-up 310a effectively provides a prompt that allows the user to select an option for how to watch the selected media.

As illustrated, the pop-up 310a presents the subscriber with two options. According to the first illustrated option (illustrated as button 320), the subscriber can watch the movie now (e.g., stream or download the movie now from the aggregator's website) for an estimated cost of 4 Megabytes to the subscriber's monthly usage allowance (e.g., according to the subscriber's DAP). In alternative implementations, the cost is presented differently, for example, as an actual cost is presented rather than the estimated cost, in dollars or some currency other than data usage, etc. According to the second illustrated option (illustrated as button 330), the subscriber can watch the movie later (e.g., download the movie at some later time for storage to the subscriber's home CDN 125), with an estimated delivery time of 24 hours, for no cost to the subscriber's DAP. Some implementations provide an actual delivery time, rather than an estimate.

FIG. 3B shows another illustrative pop-up window 310b displayed after an interaction is detected between the subscriber and plan media. In some implementations, the pop-up window 310b is displayed after interaction with a plan media icon, for example, as described with reference to FIGS. 2 and 3A. In other embodiments, the main selection page (e.g., the page shown in FIG. 2) does not indicate which media is part of the media library or media plan. Rather, any media selection is evaluated to determine whether plan media is involved, and the pop-up window 310b (e.g., or any other suitable response) is generated to reflect that selection. For example, user interactions with the interface are handled and/or a suitable response is generated via the interface as described in U.S. patent application Ser. No. 13/558,593, filed Jul. 26, 2012, titled “Page Element Identifier Pre-Classification,” which is hereby incorporated by reference in its entirety.

As illustrated in FIG. 3B, it is assumed that a user selected Season 1 of a television program, called “Parks and Recreation,” from a main selection page (e.g., the webpage 210 of FIG. 2). In response to the selection, the pop-up window 310b is generated to effectively provide a prompt that allows the user to select an option for how to watch the selected media. The pop-up window 310b presents the subscriber with a number of options. According to a first illustrated option (illustrated as button 330), the subscriber can watch the movie later (e.g., download the movie at some later time for storage to the subscriber's home CDN 125), with an estimated delivery time of 24 hours, for no cost to the subscriber's monthly usage allowance (presented as “DAP free”). According to a second illustrated option (illustrated as button 320), the subscriber can watch the movie now (e.g., stream or download the movie now from the aggregator's website) for an estimated cost of 2 Megabytes to the subscriber's monthly usage cap (e.g., according to the user's DAP). The interface also provides a region 340 presenting a set of related titles that are available to watch now “DAP Free.” For example, the alternate titles are determined to already be stored in the subscriber's home CDN 125.

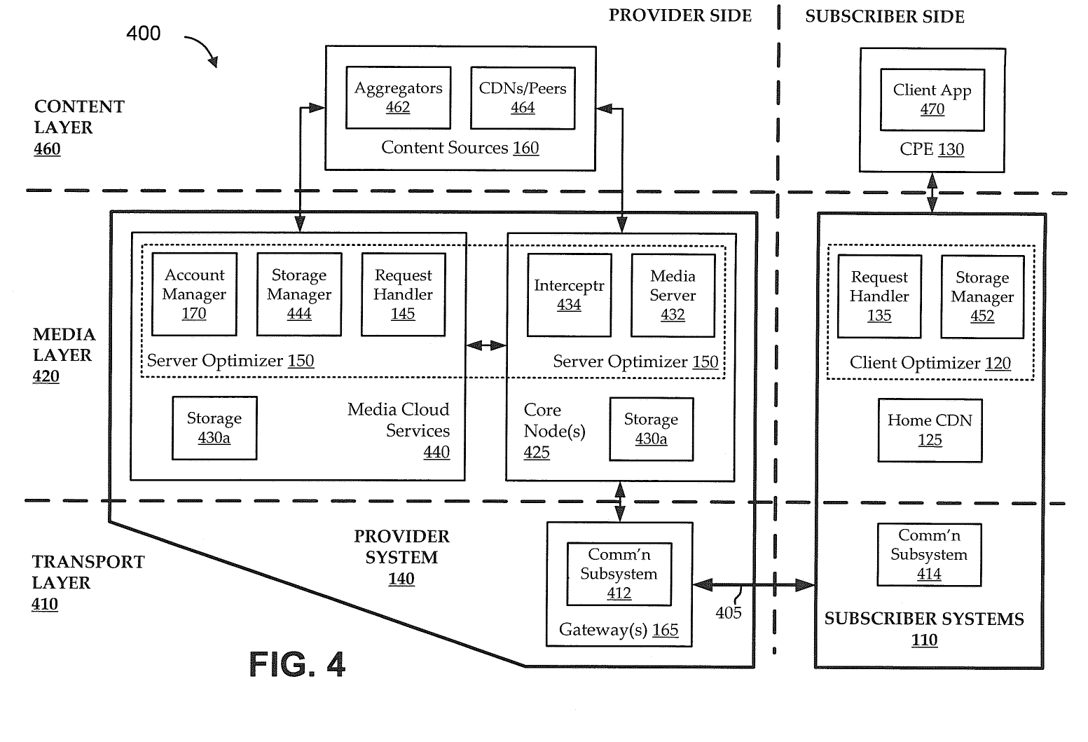

The functionality of these and/or other embodiments can be implemented in many ways without departing from the scope of embodiments. Some embodiments are implemented in a system, like the one described above with reference to FIG. 1. Other embodiments are implemented in systems, such as those described below with reference to FIGS. 4-6.

FIG. 4 shows a simplified block diagram of an illustrative communications architecture 400 in which a provider system 140 is in communication with content sources 160 and subscriber systems 110, according to various embodiments. Certain elements of FIG. 4 are numbered to correspond to elements of FIG. 1; though those elements of FIG. 4 are intended only as illustrative embodiments, and should not be construed as limiting the scope of corresponding elements of FIG. 1. For the sake of clarity, the communications infrastructure 400 can be considered as a client-server architecture having a client side and a server side. The functionality can also be considered as operating at a transport layer 410, a media layer 420, and a content layer 460. These layers are not intended to match traditional layers of the Open Systems Interconnection (OSI) model or another standard protocol or the like. Rather, the layers are intended only to provide a general categorization of functionality for added clarity and should not be construed as limiting the scope of embodiments. Embodiments of the content layer 460 generally include components for providing content data. Embodiments of the media layer 420 generally include components for determining how to handle the content data with regard to providing media and related services to subscribers. Embodiments of the transport layer 410 generally include components for handling transport of data between the provider system 140 and subscriber systems 110 at least in support of the provided media and related services.

As illustrated, content can be communicated from one or more content sources 160 to one or more end-user devices (shown as CPE(s) 130). For example, a content request can be initiated by a CPE 130 and interpreted by an associated subscriber system 110 for communication over the satellite communications environment 400. The subscriber system 110 communicates the request to a provider system 140 over a communications infrastructure (represented by link 405). The provider system 140 can then attempt to fulfill the content request by requesting and receiving content from one or more content sources 160. In an alternate use case, content can be requested by the provider system 140 (e.g., on behalf of or not on behalf of a subscriber system 110), for example, for anticipatory pre-pushing of content. In another alternate use case, content can be pushed from one or more content sources 160 and/or server system 142 to one or more subscriber systems 110.

Turning first to the provider system 140 functionality, embodiments provide and handle media and related services with subscriber systems 110 over an infrastructure illustrated by link 405. The link 405 can represent a satellite communications infrastructure or any other bandwidth-limited infrastructure in which forward link sharing can be exploited (e.g., through multicasting or the like). For the sake of simplicity, embodiments are described with reference to a satellite communications infrastructure. The provider system 140 is illustrated as a distributed architecture, with functionality spread between gateways 165, core nodes 425, and media cloud services 440. In one illustrative embodiment, gateways 165 are geographically distributed, and each includes one or more base stations for handling communications over one or more spot beams and/or carriers. Each of multiple gateways feeds into one or more core nodes 425 of a backhaul network. Each core node 425 can then have high-bandwidth, high-reliability connections to the Internet, allowing effective implementation of certain services in the “cloud” (e.g., multiple distributed servers in communication over the Internet), illustrated as media cloud services 440.

It can be desirable to move certain types of functionality upstream. For example, size, servicing, and/or other features can limit the practical amount of processing available in downstream components, such as base stations and gateways 165. Accordingly, it can be more practical to move resource-intensive processing functions to core nodes 425 and/or to the media cloud services 440. Additionally, certain types of determinations can be made better when more information is available from across larger segments of the network. For example, determinations of content popularity can benefit from information gathered across multiple carriers on multiple spot beams. This type of information can be more readily available to components that are further upstream, such that performance of related functionality by upstream devices can be beneficial in certain cases.

For the above and/or other reasons, it can be desirable to implement functionality described herein in context of distributed architectures, like the one illustrated in FIG. 4. However, many alternative architectures are possible. For example, it can be desirable in certain contexts to push some or all of the functionality shown in the media layer 420 into components of a gateway 165 or other device. Alternatively, embodiments implement substantially all the functionality using media cloud services 440 in direct communication with a gateway 165 or other transport layer 410 component. Accordingly, functionality described herein should not be construed as relying on a particular architecture, except where indicated.

In any of these or other architectures, various types of data can be communicated upstream and/or downstream to facilitate functionality by different components, at different layers, etc. For example, the communications subsystem 412 can monitor actual present usage and conditions of the link 405 with respect to subscriber systems 110, which it can communicate periodically to the upstream provider optimizer 150. The provider optimizer 150 can use this data to determine when and how to opportunistically multicast data. Data relating to these determinations can then be passed back to the communications subsystem 412 for use in determining appropriate transport protocols, link scheduling, and the like.

As illustrated, the provider system 140 interfaces with link 405 via at least a gateway 165. Embodiments of the gateway 165 implement functionality of a communications subsystem 412. Embodiments of the communications subsystem 412 are configured to handle upstream and downstream communications with the service provider's communications system, for example, a satellite communications system via one or more server-side antennas. Implementations perform various functions, including, for example, encoding (e.g., adaptively), decoding, modulating (e.g., adaptively), demodulating, applying or processing error correction techniques, baseband encapsulating, frame creation, etc. (e.g., using various modcodes, lookup tables, etc.). Other functions can include upconverting, amplifying, filtering, tuning, tracking, etc. Embodiments of the communications subsystem 412 include modem termination functionality for receiving modem traffic over the satellite link from users, for example, configured as a satellite modem termination system (“SMTS”).

Data or content requests received over the satellite communications system (e.g., from subscriber systems 110) are passed from the communications subsystem 412 to one or more functions of the provider optimizer 150 for processing. As illustrated, this can involve passing communications from a gateway 165 to its core node 425. Embodiments of the provider optimizer 150 includes a media server 432, an intercepter 434, a request handler 145, a storage manager 444, and an account manager 170. In one embodiment, the media server 432 and intercepter 434 are implemented in the core node 425, while other functions of the provider optimizer 150 are implemented in the media cloud services 440, though other module configurations and arrangements, data flows, etc. are possible according to other embodiments. In some embodiments, real-time types of data (e.g., User Datagram Protocol (“UDP”) data traffic, like Internet-protocol television (“IPTV”) programming) are routed only through certain functional blocks according to certain flows, while non-real-time types of data (e.g., Transmission Control Protocol (“TCP”) data traffic, like web video) are routed through different functional blocks according to different flows. Various embodiments of the provider optimizer 150 provide various types of application, WAN/LAN, and/or other acceleration functionality, including resource optimization and subscriber handling functions. In certain embodiments, the provider optimizer 150 implements functionality of AcceleNet™ applications from ViaSat, Inc. This functionality can be used to exploit information, for example, from application layers of the protocol stack (e.g., layers 5-8 of the IP stack) through use of software or firmware operating in the subscriber system 110 (e.g., in the subscriber systems 110 and/or the CPE(s) 130).

Requests and/or other content received at the provider system 140 can be intercepted by the intercepter 434 to determine appropriate handling. In some cases, traffic: intercepted by the intercepter 434 is passed to and processed by the request handler 145. Embodiments of the request handler 145 make various types of determinations, such as what type of content is being requested or processed or what type of request is received. In some embodiments, the request handler 145 is configured to analyze traffic to parse requests, analyze packet headers, and the like. In other embodiments, the communications subsystem 412 performs some or all of those functions, so that the request handler module 442 receives data that is ready for processing.

Some embodiments of the request handler 145 categorize content in various ways and handle the content according to the classification. For example, content can be classified as “cacheable” (or “non-cacheable”) and/or “delayable” (or “non-delayable”), and handled opportunistically, as described in U.S. patent application Ser. No. 13/569,811, filed on Aug. 8, 2012, titled “OPPORTUNISTICALLY DELAYED DELIVERY IN A SATELLITE NETWORK,” which is hereby incorporated by reference in its entirety. For example, delayable content can be handled using delaycasting and/or related techniques, as described herein and in above-incorporated U.S. patent application Ser. No. 13/569,811. As described above, embodiments can classify content as delayable according to an explicit request by one or more subscribers to delay delivery of the content. For example, a subscriber opts, via a prompt on a CPE 130, to delay delivery of a requested content object in exchange for an offer (e.g., a reduced hit to the subscriber's DAP). Also as described above, embodiments can determine whether an object is of a type that is subject to an offer (e.g., whether it is media being offered under a media plan), what types of offers are available (e.g., according to the subscriber's DAP, presently available network resources, other scheduled content, etc.), etc.

In some embodiments, the request handler 145 includes functionality of or is in communication with the account manager 170. In some implementations, each subscriber or groups of subscribers have contractual relationships with the communications services provider. For example, subscribers can be associated with a plan that guarantees them a certain amount of resources (e.g., a total bandwidth consumption cap per month) for a certain price (e.g., with an associated DAP). Various plans can be offered, and various interactions can affect plan pricing, content delivery, etc. For example, subscribers can be able to pay extra for certain content (e.g., on-demand movies, pay-per-view events, etc.) or make decisions that reduce the impact of content delivery on their caps.

In one embodiment, the account manager 170 collects data from multiple components to determine how much network usage to attribute to a particular user. For example, the account manager 170 can determine how to count upload or download traffic against a user's DAP. In another embodiment, the account manager 170 dynamically adjusts DAPs (or costs of media to subscriber DAPs) according to various network link and/or usage conditions. For example, the account manager 170 can adjust DAPs to encourage network usage during lower traffic times. In yet another embodiment, the account manager 170 affects the operation of other components of the provider system 140 as a function of certain DAP and/or other accounting conditions. For example, the account manager 170 can direct the communications subsystem 412 to multicast certain types of data or to prevent certain users from joining certain multicast streams as a function of DAP or other considerations.

It is worth noting that embodiments of the account manager 170 can be used to facilitate many different types of functions relating to subscriber accounts. Some embodiments keep track of subscriber usage and subscription limits, and notify other components of the provider system 140 accordingly. Other embodiments handle subscriber credentials, digital rights management issues, and/or the like to police the types of content that can be received from and/or sent to subscribers. For example, a subscriber can request a content channel only available to certain subscription levels, content requiring a login or other credentials, content from blocked or throttled websites, etc. Still other embodiments handle groups of subscribers, subscriber preferences, etc.

Many of the functions described herein are facilitated by embodiments of the storage manager 444 exploiting resources of one or more data stores of a storage subsystem 430. The storage subsystem 430 can include storage resources in the core nodes 425 and/or provided via media cloud services 440. In some embodiments, the storage subsystem 430 includes storage resources of the gateways 165 or other components (though not shown). Some embodiments facilitate extended subscriber storage, such as for subscriber-owned photos, movies, documents, etc. Other embodiments of the storage manager 444 use the storage subsystem 430 to facilitate edge server functionality, CDN functionality, or the like. The storage subsystem 430 can include any useful types of data storage, including, for example, servers, queues, buffers, drives, and/or the like.

Some embodiments of the storage subsystem 430 also include subscriber dictionaries. Embodiments of the provider optimizer 150 (e.g., the storage manager 444) use various dictionary coding techniques to provide functionality, such as monitoring contents of subscribers' home CDNs 125, identifying redundancies between incoming data and data previously sent across the links of the communication system, etc. In particular, various techniques (e.g. delta coding, wide dictionary coding, etc.) can allow identification of redundancies in or matches between byte sequences traversing the links. These techniques can be used to identify and exploit opportunities for multicasting (e.g., delaycasting) to increase utilization of the communications links.

In a first illustrative scenario, a first subscriber requests download of an email. It can be determined that the email is non-delayable and/or non-cacheable, so that it is appropriate to deliver the email only to the requesting subscriber and to attempt delivery as soon as possible in response to the request. The email content can be assigned to a unicast service flow associated with the requesting subscriber, and scheduled for delivery (e.g., using private IP). In a second illustrative scenario, the first subscriber requests download of a popular movie. It can be determined that the movie is non-delayable (the requester wants to watch the movie now), but the content is cacheable. Accordingly, it can be appropriate to deliver the movie to all subscribers sharing the requester's carrier as a multicast communication (e.g., for immediate viewing by the requester and for opportunistic caching by the non-requesting subscribers). The movie content can be assigned to one or more multicast service flows and scheduled for immediate delivery. In a third illustrative scenario, the first subscriber requests download of a popular movie, but agrees to delay delivery of the movie for a reduced account hit. It can be determined that the movie is delayable and cacheable. Accordingly, it can be appropriate to deliver the movie to all subscribers sharing the requester's carrier as a multicast communication, but that delivery can be delayed for some time. The movie content can be assigned to one or more delaycast service flows for opportunistically delayed delivery.

As described above, embodiments of the provider system 140 receive content data from content sources 160 that can be destined for one or more subscribers (e.g., one or more subscriber systems 110 in a spot beam 410). The content sources can include content aggregators 462 (e.g., an Internet movie subscription site), CDNs 464, and/or any other types of content sources (e.g., sources having a peering relationship with the provider system 140, etc.). As illustrated, the content sources 160 can be in communication with the core nodes 425 and/or with the media cloud services 440. In some embodiments, additional components are included for interfacing with the content sources 160. Interface components can include network switches, routers, edge servers, traffic shapers, etc. For example, third-party edge servers can be adapted to mirror content (e.g., implementing transparent mirroring, like would be performed in a point of presence (“POP”) of a CDN) to the provider system 140 by facilitating contractual relationships between content providers and service providers to move content closer to users in a communications network. Traffic shapers can control traffic flow through the provider system 140, for example, to help optimize performance of the communications system (e.g., by reducing latency, increasing effective bandwidth, etc.). In one embodiment, a traffic shaper is used to delay packets in a traffic stream to conform to a predetermined traffic profile.

According to certain scenarios, the provider system 140 receives data from the content sources 160 destined for one or more users in response to explicit requests by the one or more users. The provider system 140 intercepts the data using the intercepter 434, processes the data as appropriate (e.g., using components of the provider optimizer 150), and can re-serve the data using embodiments of the media server 432. For example, a user's selection of a television channel, on-demand video, website, and/or other content can result in a request to and a response from a content source 160. According to other scenarios, the provider system 140 receives data from the content sources 160 destined for one or more users in response to implicit requests by the one or more users. For example, user profiles or preferences, content request trends, and/or other techniques can be used to anticipate or assume implicit requests by users for content. According to still other scenarios, the provider system 140 receives data from the content sources 160 destined for one or more users without any relation to a request. For example, broadcast content, certain anticipatory content, and/or other types of content can be communicated over the communications system on behalf of the communications service provider and/or one or more content service providers (e.g., served by the media server 432).

Functionality of the provider optimizer 150 can be used to determine which content objects to assign to particular queues or service flows, which content to send over the communications links 405, and to which user or users, etc. In determining how to communicate the content objects over the communications links 405, additional determinations can be made by the provider optimizer 150 or other components of the provider system 140. For example, it can be desirable to determine whether content should be unicast or multicast and according to which protocol, how content should be modulated and/or encoded, how content should be assigned to one or more spot beams and/or carriers, how content should be reformatted (e.g., compressed, transcoded, etc.), etc. In some embodiments, some or all of these and other functions are provided by the communications subsystem 412. In other embodiments, certain of these determinations are made by the provider optimizer 150, and others are made by the communications subsystem 412.

For the sake of illustration, embodiments of the communications subsystem 412 apply one or more transport protocols to content being sent to one or more subscribers over the communications links 405. Some implementations apply one or more unicast or multicast protocols to facilitate corresponding service flows, prepare datagrams by generating header information and packets of particular formats, etc. Other implementations apply one or more modcodes to the data (i.e., modulation and/or encoding schemes). The modcodes can, for example, be applied as a function of the type of data being sent (e.g., higher priority data can be sent with more robust modcodes), link conditions (e.g., more robust modcodes can be used with poor link conditions, such as high detected bit errors resulting from rain fade), etc. In some cases, the communications subsystem 412 monitors link conditions and dynamically and adaptively applies modcodes according to changes in link conditions (e.g., using adaptive coding and modulation (ACM) techniques). Protocol application can further include applying progressive encoding techniques (e.g., using progressive video encoding for base and enhancement video layers), applying encryption or other rights management (e.g., digital rights management (DRM)), etc. Embodiments of the communications subsystem 412 feed information back to the provider optimizer 150 for optimizing subscriber assignments.

When content traffic is has been prepared for communication, embodiments of the communications subsystem 412 can schedule transport over the link 405. For example, link scheduling can involve managing link bandwidth by scheduling license grants within a spot beam. In certain embodiments, the communications subsystem 412 is aware of certain contractual allowances or obligations (e.g., via communications with the account manager 170) so that the scheduling of the link can account for rate-based and/or other policy considerations. In other embodiments, this information is maintained by upstream components (e.g., the account manager 170) and control information based on this information is communicated as needed to the communications subsystem 412. Preparing the content traffic for communication over the satellite communications links can involve other functions that can be performed by the communications subsystem 412. For example, the communications subsystem 412 can oversee or implement a variety of decoding, interleaving, decryption, and unscrambling techniques for upstream traffic and/or downstream traffic.

The functionality above is largely described with reference to server-side components. Certain functionality is facilitated (or supported) by components of the subscriber systems 110 and/or by joint functionality of server-side and client-side components. For example, client-server functionality can be facilitated by interactions between the server-side media server 432 and the client-side client application 470, with support from a number of other server- and client-side components.

Turning to the subscriber systems 110, various implementations are possible. For example, the user system can be implemented as a subscriber modem (e.g., a satellite modem), a dedicated device, hardware or software of a set-top box, or in any other useful way. In one illustrative implementation, the subscriber system 110 is embodied in a subscriber modem that includes a subscriber optimizer 120 (e.g., as integrated hardware and/or software) and has one or more ports for communicating with a home CDN 125 and one or more CPEs 130. For example, the subscriber modem has a universal serial bus (USB) port, and the home CDN 125 is implemented on a USB thumb drive. In other implementations, the home CDN 125 can be implemented using internal storage of the modem or as other types of removable storage, networked storage, etc. The CPEs 130 can include televisions or video monitors, computers (e.g., laptops, tablets, etc.), smart phones, smart appliances, and/or any other equipment that can benefit from services provided over the communications infrastructure (and/or support equipment thereto).

Similar to the server-side functions described above, the client-side functions can be considered as transport layer 410, media layer 420, and content layer 460 functions. At the transport layer 410, data communicated over the communications link 405 can be handled using a communications subsystem 414. In some embodiments, the communications subsystem 414 of the subscriber system 110 performs similar or identical functionality to that of the communications subsystem 412 of the provider system 140. For example, when a signal is received via the communications subsystem 414, the communications subsystem 414 can amplify the signal, acquire the carrier, downconvert the signal, etc. Though not explicitly shown, other components and/or component functionality can be provided by the communications subsystem 414. For example, a media access control (MAC) module can provide certain network interface functionality, such as modulating, encoding, filtering, decrypting, and/or otherwise processing data. Other functionality can be provided by routers, switches, and/or the like. These and/or other components can also process data upon receipt and/or prior to transmission using techniques, such as modulating and demodulating, encoding and decoding, multiplexing and de-multiplexing, filtering, parsing, packetizing, etc.

Embodiments of the communications subsystem 414 can also include other communications functionality for supporting local and/or other networking. In some embodiments, the communications subsystem 414 includes a hub, router, or the like for supporting a local area (e.g., WiFi) network. In other embodiments, the communications subsystem 414 supports other types of wired or wireless functions, such as Bluetooth, Ethernet, femtocell, or other functionality.

Media layer 420 functionality of the client system can be handed by a subscriber optimizer 120 and a home CDN 125. The subscriber optimizer 120 can be tailored to provide support for the media and related services facilitated by the provider optimizer 150, including those described above. For example, the subscriber optimizer 120 can perform functions relating to WAN/LAN, and/or other acceleration functionality as a proxy, an in-line accelerator, etc. As illustrated, the subscriber optimizer 120 includes a request handler 135 and a storage manager 452. In some embodiments, the request handler 135 of the subscriber system 110 performs at least functions that are complementary to those of the request handler 145 of the server system, and the storage manager 452 of the subscriber system 110 performs functions that are complementary to those of the storage manager 444 of the server system.

In general, embodiments of the request handler 135 can bridge interactions between users and the subscriber system 110 with interactions between the subscriber system 110 and the communications infrastructure. For example, the request handler 135 can interact with users via one or more graphical user interfaces GUIs (e.g., via a CPE 130) to receive content requests, interpret those user requests, and handle (e.g., fulfill) those user requests locally and/or via the communications infrastructure (e.g., by fulfilling content requests via the home CDN 125, prompting the user for additional information via the CPE 130, issuing requests over the communications infrastructure, etc.).

Many of the functions described herein are facilitated by client-side storage, referred to herein as the home CDN 125. The home CDN 125 can include any types of storage, and those types of storage can be spread across one or more devices in one or more locations. For example, the home CDN 125 can include volatile or non-volatile storage, servers, files, queues, etc. implemented in or in communication with a subscriber modem, a set-top box, a local or non-local network, a CPE 130, etc. The data stores can be fully integrated and/or co-located, implemented as internal hard-disk drives, internal solid-state memory, attached peripherals (e.g., thumb drives, USB hard drives, etc.), wireless or networked peripherals (e.g., wireless drives, storage area networks, etc.), cloud storage, etc. Some functionality involves ensuring that certain types of data are stored locally.

In some embodiments, the storage manager 452 maintains, affects, and/or communicates information relating to the data stored in the home CDN 125. For example, the storage manager 452 can upload information to the provider system 140 (via other components) to indicate when data is added to the subscriber libraries (e.g., in the form of an ACK or similar message), when data is removed from the subscriber libraries, etc. Embodiments of the storage manager 452 can also determine when newer content objects should replace older content objects in the subscriber libraries, when content objects in the subscriber libraries have become stale (e.g., because the content or related rights have expired, because newer version of the content exist, because the content is associated with a limited valid timeframe, etc.), when additional data is needed to fill in holes in content objects stored at the subscriber libraries, etc.

As illustrated, user interactions typically occur at the content layer 460 via one or more CPEs 130. The CPEs can include any content-enabling device, such as a computer (e.g., tablet, laptop, etc.), television, set-top box, smart phone, media player, etc. Embodiments of the CPEs 130 include at least one client application 470 for facilitating media services or related functionality. In some embodiments, the client application 470 is a web browser. In other embodiments, the client application 470 includes software code configured to run on a processor of the CPE 130 (e.g., on a set-top box).

Some implementations provide different content communication paths between components of the subscriber system 110. For the sake of illustration, suppose a user requests a movie using a GUI displayed via a CPE 130 (e.g., a television). If the request is for a private video file (e.g., a home movie, a purchased video, etc.) stored on the user's digital video recorder (e.g., the DVR is implemented as part of the home CDN 125), some implementations can allow the request to be handled directly by the DVR. For example, the DVR is part of a set-top box that handles the request without assistance from other components of the subscriber system 110. Alternatively, the request is processed by the request handler 135, which determines that the subject of the request is locally available and directs the request to be fulfilled locally (the request handler 135 can also log the request, communicate details about the request to the provider system 140 for statistical processing, etc.). If the request is for other types of movies, the request handler 135 can determine whether to fulfill the request locally, to process the request over the communications infrastructure (e.g., issue a request to a remote content source via the provider system 140), to partially fulfill the request locally and fill in missing data using requests over the communications infrastructure, etc.

The architecture 400 described above is one of many possible architectures for performing the functions described herein. For example, each component can be implemented in different ways, including using one or more components, hardware and/or software, custom and/or off-the-shelf components, etc. Accordingly, though embodiments are described herein with reference to particular components providing particular functionality as part of particular subsystems, similar functionality can be provided in other ways (e.g. by other components and/or at other locations in the architecture) without departing from the scope of embodiments. Further, though some components are similarly named in the provider system 140 and the subscriber systems 110, the similarity in names is intended only to add clarity and simplicity to the disclosure and not to imply that the components are implemented identically or perform identical functionality. Even further, the provider system 140 and the subscriber systems 110 can perform many other types of functionality and/or can include other components not discussed above.

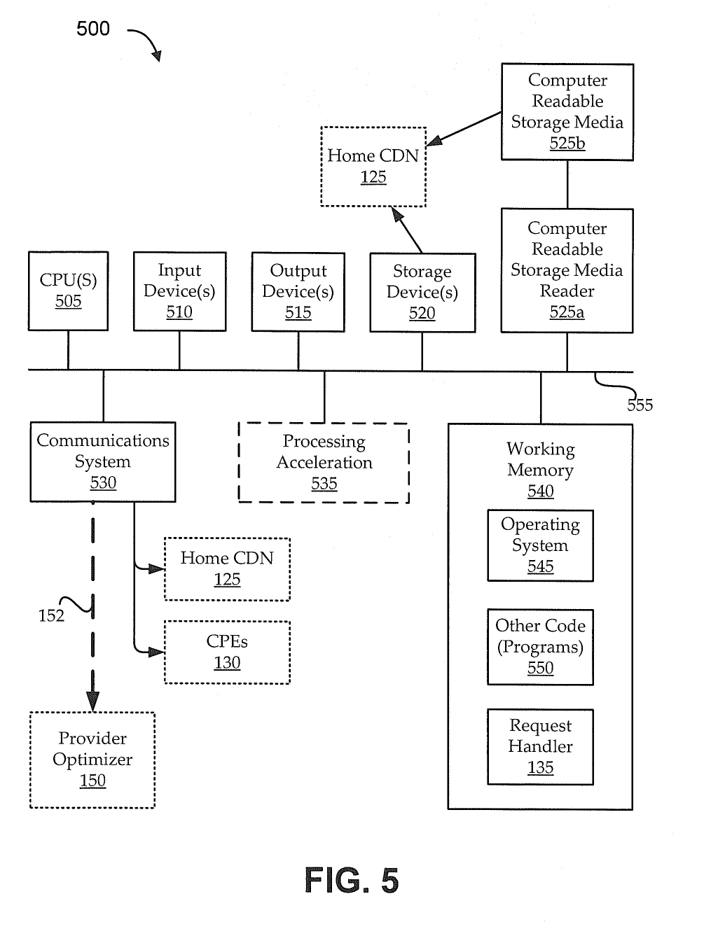

FIG. 5 shows an illustrative computational system 500 for implementing functionality of a subscriber optimizer 120, according to various embodiments. The computational system 500 can include or perform functionality of components of subscriber optimizer 120 embodiments, such as those described above in FIGS. 1 and 4. For the sake of simplicity, the computational system 500 is shown including hardware elements that can be electrically coupled via a bus 555. However, embodiments of the computational system 500 can be implemented as or embodied in single or distributed computer systems, in one or more locations, or in any other useful way.

The hardware elements can include one or more central processing units (CPUs) 505, one or more input devices 510 (e.g., a mouse, a keyboard, etc.), and one or more output devices 515 (e.g., a display device, a printer, etc.). The computational system 500 can also include one or more storage devices 520. By way of example, storage device(s) 520 can be disk drives, optical storage devices, solid-state storage device such as a random access memory (RAM) and/or a read-only memory (ROM), which can be programmable, flash-updateable and/or the like. In some embodiments, the storage devices 520 include or are in communication with the home CDN 125 of the subscriber system 110, as described above.

The computational system 500 can additionally include a computer-readable storage media reader 525a, a communications system 530 (e.g., a modem, a network card (wireless or wired), an infra-red communication device, etc.), and working memory 540, which can include RAM and ROM devices as described above. In some embodiments, the computational system 500 can also include a processing acceleration unit 535, which can include a DSP, a special-purpose processor and/or the like.

The computer-readable storage media reader 525a can further be connected to a computer-readable storage medium 525b, together (and, optionally, in combination with storage device(s) 520) comprehensively representing remote, local, fixed, and/or removable storage devices plus storage media for temporarily and/or more permanently containing computer-readable information. In some embodiments, the home CDN 125 is implemented, in whole or in part, as computer-readable storage media 525b. The communications system 530 can permit data to be exchanged with a network and/or any other computer described above with respect to the computational system 500. For example, as described with reference to FIGS. 1 and 4, content traffic and/or other information can be communicated via the communications system 530 to the home CDN 125 (if implemented as a separate one or more components from the subscriber optimizer), one or more CPEs 130, the provider optimizer 150 (e.g., over communications link 152), etc.

The computational system 500 can also include software elements, shown as being currently located within a working memory 540, including an operating system 545 and/or other code 550, such as an application program (which can be a client application, web browser, mid-tier application, relational database management system (RDBMS), etc.). In some embodiments, one or more functions of the subscriber optimizer 120 are implemented as application code 550 in working memory 540. For example, as illustrated, functionality of the request handler 135 can be implemented as code of the working memory 540 (e.g., as part of the other code 550).

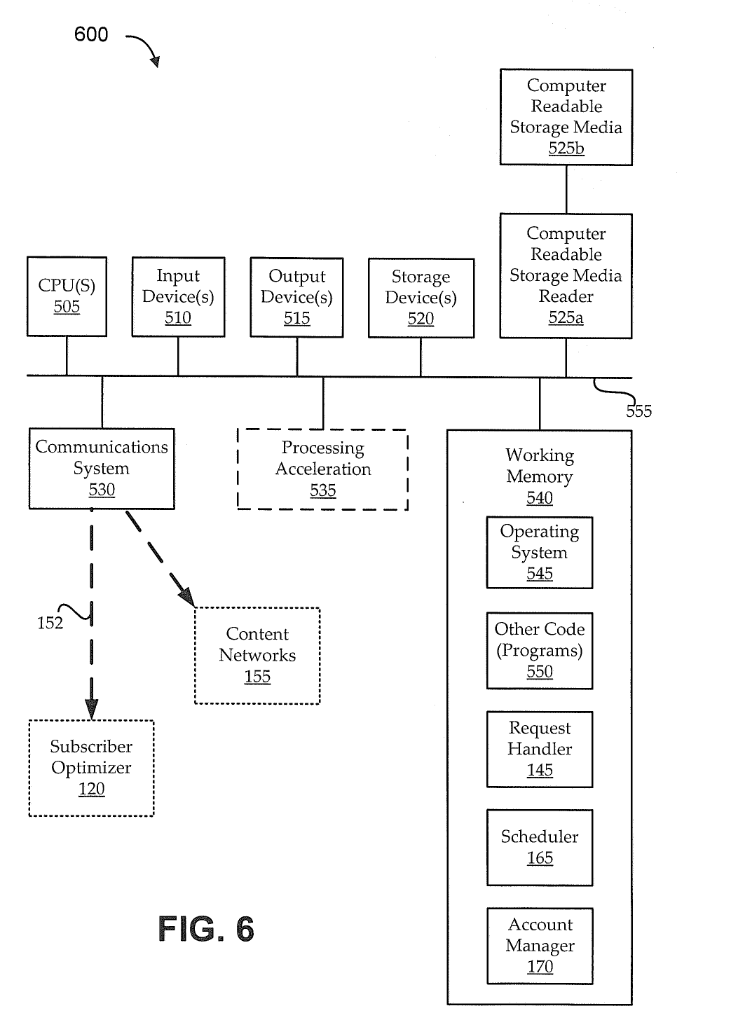

FIG. 6 shows an illustrative computational system 600 for implementing functionality of a provider optimizer 150, according to various embodiments. The computational system 600 can include or perform functionality of components of provider optimizer 150 embodiments, such as those described above in FIGS. 1 and 4. For the sake of simplicity, elements of the computational system 600 that are similar to those of the computational system 500 of FIG. 5 are illustrated with the same reference numerals and are not described again. In some embodiments, however, corresponding components of the computational systems are implemented differently, according to their different uses, environments, etc. For example, implementations can use residential-grade components in the computational system 500 and commercial-grade components in the computational system 600. Further, while the same basic components and architecture are illustrated, each computational system can be architected as appropriate for its functional and physical context.

The computational system 600 is shown with a number of elements that can be electrically coupled via a bus 555, including one or more CPUs 505, one or more input devices 510, one or more output devices 515, one or more storage devices 520, a computer-readable storage media reader 525a (that can be connected to a computer-readable storage medium 525b), a communications system 530, a processing acceleration unit 535, and working memory 540. The communications system 530 can permit data to be exchanged with a network and/or any other computer described above with respect to the computational system 600. For example, as described with reference to FIGS. 1 and 4, content traffic and/or other information can be communicated via the communications system 530 to multiple subscriber optimizers 120 (e.g., over communications link 152) and one or more content networks 155. In some embodiments, one or more functions of the provider optimizer 150 are implemented as application code 550 in working memory 540. For example, as illustrated, functionality of the request handler 145, scheduler 165, and account manager 170 can be implemented as code of the working memory 540 (e.g., as part of the other code 550).

It should be appreciated that alternate embodiments of computational systems 500 and 600 can have numerous variations from that described above. For example, customized hardware might also be used and/or particular elements might be implemented in hardware, software (including portable software, such as applets), or both. Further, connection to other computing devices such as network input/output devices can be employed. In various embodiments of computational systems, like the ones illustrated in FIGS. 5 and 6, are used to implement one or more functions of a subscriber optimizer 120 and/or provider optimizer 150, and the computational system is in communication with other functional components as needed or desired. In other embodiments, computational systems like the one illustrated in FIGS. 5 and 6 are used to implement one or more methods of the system, such as those described below.

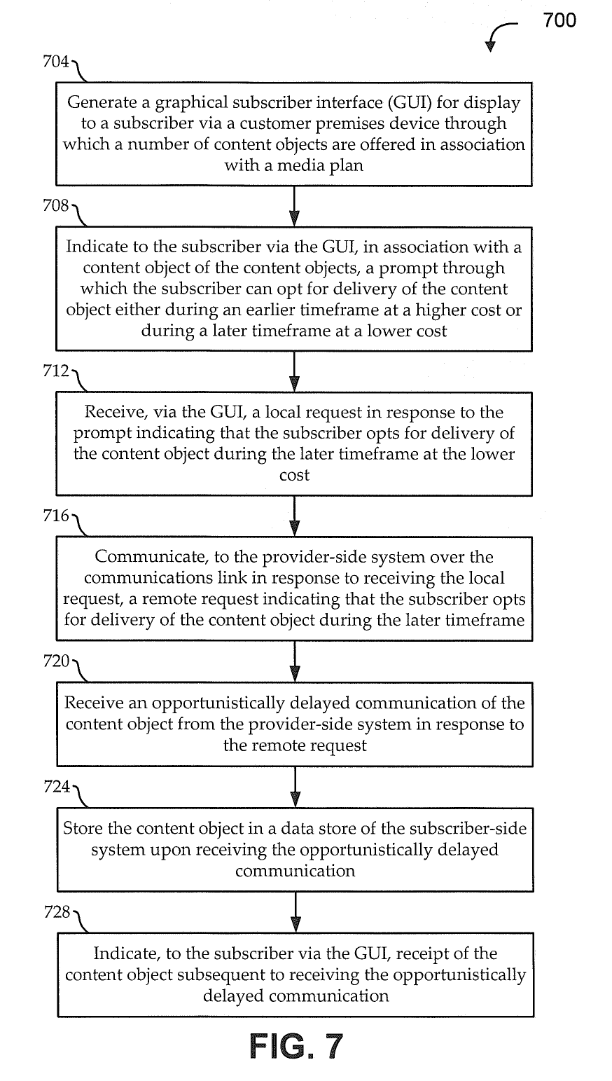

Turning to FIG. 7, a flow diagram is shown of an illustrative method 700 for subscriber-driven resource shifting, according to various embodiments. The method 700 is described in context of a subscriber system operating within a communications infrastructure, for example, like the subscriber systems 110 described above with reference to FIGS. 1-6. The same or similar techniques can be applied to any type of subscriber system that operates within a communications infrastructure configured to provide an at least partially shared forward link to a lease some users of the link. For example, as described above, satellite and certain other wireless infrastructures can allow sharing of bandwidth resources using multicasting and/or other techniques.

Embodiments of the method 700 begin at stage 704 by generating a graphical user interface (GUI) for display to a user via a customer premises device. The GUI shows a number of content objects that are offered in association with a media plan. The GUI can be displayed on a computer, smart phone, television, or other customer premises device of a subscriber to the media plan. For example, the GUI is associated with a webpage of a content aggregator website and is displayed via a browser interface of a subscriber computer.

At stage 708, an indication including a prompt is presented to the subscriber via the GUI, in association with one of a number of content objects displayed on the GUI. Through the prompt, the subscriber can opt for delivery of the content object either during an earlier time frame at a higher cost or during a later time frame at a lower cost. For example, the prompt is presented to the subscriber in response to the subscriber interacting with one of the displayed content objects (e.g., when the subscriber clicks on an icon corresponding to one of the available content objects). As described above, the prompt can be presented to the subscriber in any suitable way, including, for example, as a pop-up with buttons.

In some embodiments, the subscriber is presented with only two options: an option to receive (e.g., watch, listen to, download, etc.) the selected content object now or relatively sooner; and an option to receive the selected content object relatively later. In other embodiments, the subscriber is presented with more than two options. For example, the subscriber can be presented with a number of time frame options each having an associated cost to receive the content during that timeframe, and/or other types of options. The cost associated with each option can be presented to the subscriber in any suitable terms. For example, an option for delayed delivery of the requested content object can be offered in exchange for a reduction in monetary price, a reduction in a hit to the subscriber's DAP, a reduction in future bandwidth throttling associated with the subscriber, credits to the subscriber for future content requests, a reduction in ads associated with viewing the content, a change in rights management options associated with the content, and/or any other reduced debit, increased credit, promotional opportunity, etc. In some embodiments, the timeframes and/or costs associated with each option are predetermined (e.g., each is pre-governed by the subscriber's DAP, each is consistent across all qualifying content objects, etc.). In other embodiments, the timeframes and/or costs associated with each option are dynamically determined according to one or more parameters. For example, the parameters can relate to the subscriber's DAP, to present network resource availability, to rights and/or costs associated with the requested content, etc.

At stage 712, a local request is received, via the GUI, indicating that the user opts for delivery of the content object during the later time frame at the lower cost. For the sake of illustration, the subscriber views an electronic program guide on a television, an electronic program guide shows a listing of on-demand movies. The subscriber selects one of the on-demand movies using a remote control or other pointing device. In response to the selection, the prompt is displayed on the television screen providing the subscriber with options in association with the selected on-demand movie. The subscriber interacts with the prompt in such a way as to opt for delayed delivery of the on-demand movie in exchange for a reduced hit to the subscriber's DAP. The subscriber's selection and option for delayed delivery is communicated to the subscriber optimizer (e.g., in a subscriber modem, set top box, etc.).

At stage 716, the local request (or information corresponding to the local request) is communicated over the communications link from the subscriber-side system to a provider-side system. In some embodiments, a subscriber optimizer at the subscriber-side system communicates with a provider optimizer at the provider-side system over a logical tunnel or other link. For example, the subscriber optimizer is a client application in communication with a server application of the provider optimizer over a client-server link.

In some embodiments, the method 700 proceeds with various stages in response to the subscriber's request for delayed delivery of the content object. At stage 720, embodiments receive an opportunistically delayed communication of the content object at the subscriber-side system from the provider-side system in response to the request for delayed delivery. For example, the network looks for time- and/or demand-shifting opportunities by which to communicate the requested content to the requesting subscriber within the selected delayed timeframe and with a reduced impact on network infrastructure resources. At stage 724, as the opportunistically delayed communication of the content object is received at the subscriber-side system, the content object is stored in a local data store. For example, as data (e.g. packets, chunks, etc.) of the requested content object is received by the subscriber optimizer, the subscriber optimizer directs the data to be stored in the subscriber's home CDN. In some cases, particularly where the content object is being delivered opportunistically over time, portions of the content object are received at different times, or sometimes not at all. Accordingly, embodiments of the subscriber optimizer maintain or are able to obtain information about which portions of the content object have been reliably delivered to the subscriber's home CDN. In some embodiments, this information is indicated to the subscriber. At stage 728, an indication can be provided to the subscriber (e.g., via the GUI) that the content object has been received. For example, the subscriber can view a status of delayed requests via the same or different GUI, and the status can show content that has been fully delivered (e.g., movies ready to be watched), download progress (e.g., a percentage of a content object that has been received or has not yet been received), estimates of completion times, and/or any other useful information.

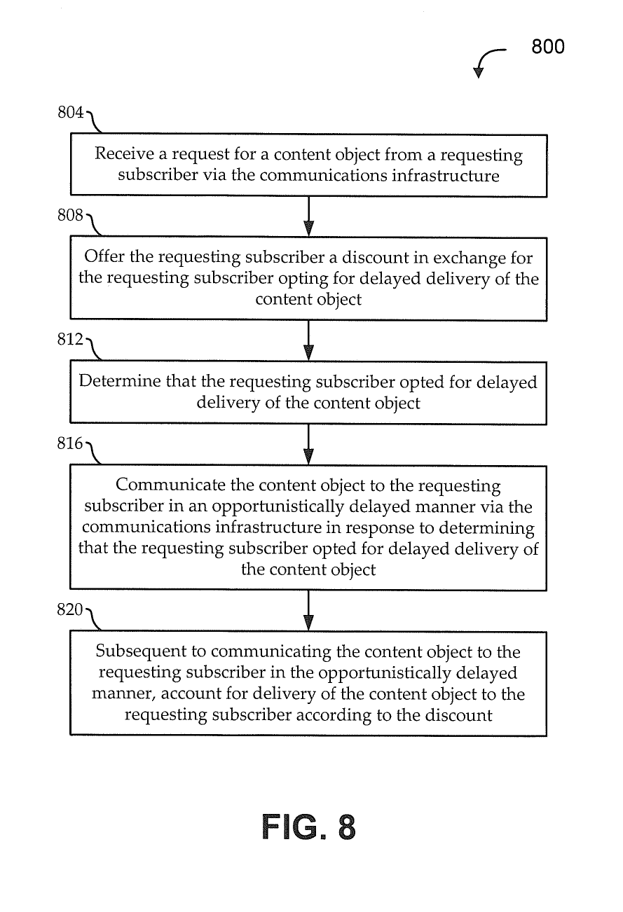

FIG. 8 shows a flow diagram of another illustrative method 800 for subscriber-driven resource shifting, according to various embodiments. The method 800 is described in context of a provider system operating within a communications infrastructure, for example, like the provider systems 140 described above with reference to FIGS. 1-6. The same or similar techniques can be applied to any type of provider system that operates within a communications infrastructure configured to provide an at least partially shared forward link to at least some of a number of subscriber systems over the link.

Embodiments of the method 800 began at stage 804 by receiving a request for a content object from a requesting subscriber via the communications infrastructure. As described above, certain implementations display a GUI to subscriber through which a number of content objects are presented for retrieval (e.g., streaming, downloading, etc.) by the subscriber. Prior and/or subsequent to displaying the various content objects via the GUI, determinations can be made as to whether each content object can be offered at different timeframes (e.g., whether each content object is delayable under a media plan). In some embodiments, the request received at stage 804 is for a content object that is determined to be delayable under a media plan or otherwise available at different timeframes.

At stage 808, an offer is presented to the requesting subscriber for a discount in exchange for the requesting subscriber opting for delayed delivery of the requested content object. For example, the subscriber can be presented with options that include an offer to receive the content object at an earlier timeframe for a higher cost and an alternative offer to received content object at a later timeframe for a lower cost. According to some embodiments, the provider system (e.g., a provider optimizer) communicates the offer to the subscriber system of the requesting subscriber. The provider system can generate the offer based solely on a determination that the content object is delayable according to a media plan. Alternatively, the provider system can generate the offer based on additional information, for example, particular characteristics of the subscriber's DAP, presently available network infrastructure resources, network infrastructure resources predicted to be available in the future, usage trends and/or patterns relating to the requesting subscriber and/or other subscribers, etc. The offer can be presented to the requesting subscriber as a prompt through a GUI of the subscriber's CPE, or in any other suitable way.

At stage 812, a determination is made at the provider system that the requesting subscriber opted for delayed delivery of the content object. For example, the communication is received from the subscriber system indicating that the requesting subscriber interacted with the presented offer in such a way as to indicate an explicit option for delayed delivery of the content object. In some implementations, in response to the determination, the content object is queued and/or otherwise scheduled for delayed delivery. Other determinations can also be made, including, for example, prioritizing and/or scoring the object in support of queuing the object for delayed delivery with respect to other previously queued objects, estimating an object size and/or expected delivery time for the content object, etc.

At stage 816, the content object is communicated to the requesting subscriber in a delayed manner according to the offer and the explicit option of the requesting subscriber to receive the content object in the delayed manner. In some embodiments, the content object is communicated in an opportunistically delayed manner, such that various time- and/or demand-shifting opportunities are exploited in the communication of the content object data. Certain embodiments use various techniques to ensure delivery of the content object at least within the later timeframe presented as part of the offer to the requesting subscriber. Communicating the content object of the requesting subscriber can involve unicasting and/or multicasting some or all of the content object data. In some implementations, the content object data is stored locally to the subscriber system of the requesting subscriber as it is received.

In some embodiments, additional functionality occurs as and/or after the content object data is delivered to the requesting subscriber. At stage 820, embodiments account for delivery of the content object to the requesting subscriber according to the discount provided as part of the offer. For example, the provider system may wait to apply any accounting (e.g., to debit against the subscriber's DAP, charge the subscriber's account, etc.) until the content object has been fully delivered and stored at the subscriber's home CDN. Other embodiments send updates to the subscriber system to facilitate display of status information, account information, and/or other information via the GUI.

The methods disclosed herein include one or more actions for achieving the described method. The method and/or actions can be interchanged with one another without departing from the scope of the claims. In other words, unless a specific order of actions is specified, the order and/or use of specific actions can be modified without departing from the scope of the claims.

The various operations of methods and functions of certain system components described above can be performed by any suitable means capable of performing the corresponding functions. These means, including embodiments of subscriber system 110 and/or provider system 140 components, can be implemented, in whole or in part, in hardware. Thus, they can include one or more Application Specific Integrated Circuits (ASICs) adapted to perform a subset of the applicable functions in hardware. Alternatively, the functions can be performed by one or more other processing units (or cores), on one or more integrated circuits (ICs). In other embodiments, other types of integrated circuits can be used (e.g., Structured/Platform ASICs, Field Programmable Gate Arrays (FPGAs), and other Semi-Custom ICs), which can be programmed. Each can also be implemented, in whole or in part, with instructions embodied in a computer-readable medium, formatted to be executed by one or more general or application specific controllers. Embodiments can also be configured to support plug-and-play functionality (e.g., through the Digital Living Network Alliance (DLNA) standard), wireless networking (e.g., through the 802.11 standard), etc.

The steps of a method or algorithm or other functionality described in connection with the present disclosure, can be embodied directly in hardware, in a software module executed by a processor, or in a combination of the two. A software module can reside in any form of tangible storage medium. Some examples of storage media that can be used include random access memory (RAM), read only memory (ROM), flash memory, EPROM memory, EEPROM memory, registers, a hard disk, a removable disk, a CD-ROM and so forth. A storage medium can be coupled to a processor such that the processor can read information from, and write information to, the storage medium. In the alternative, the storage medium can be integral to the processor.

A software module can be a single instruction, or many instructions, and can be distributed over several different code segments, among different programs, and across multiple storage media. Thus, a computer program product can perform operations presented herein. For example, such a computer program product can be a computer readable tangible medium having instructions tangibly stored (and/or encoded) thereon, the instructions being executable by one or more processors to perform the operations described herein. The computer program product can include packaging material. Software or instructions can also be transmitted over a transmission medium. For example, software can be transmitted from a website, server, or other remote source using a transmission medium such as a coaxial cable, fiber optic cable, twisted pair, digital subscriber (DSL), or wireless technology such as infrared, radio, or microwave.

Other examples and implementations are within the scope and spirit of the disclosure and appended claims. For example, features implementing functions can also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein can be utilized. Accordingly, the appended claims include within their scope such processes, machines, manufacture, compositions of matter, means, methods, or actions.

1. A method for resource shifting in a communications infrastructure that provides sharing of a shared communications link over which a plurality of subscriber-side systems are in communication with a provider-side system, the method comprising:
generating, by a subscriber-side system, a graphical user interface (GUI) for display to a user via a customer premises device through which a plurality of content objects is offered in association with a media plan;
determining, in response to a user interaction via the GUI with one of the plurality of content objects, whether to offer delivery of the content object during multiple timeframes at different associated costs as a function of other content objects that are presently scheduled for delivery over the shared communications link in response to requests from others of the plurality of subscriber-side systems;
indicating to the user via the GUI, according to the determining, a prompt providing user selection between delivery of the content object during an earlier of the timeframes at a higher cost and delivery of the content object during a later of the timeframes at a lower cost;
receiving, by the subscriber-side system via the GUI, a local request in response to the prompt indicating that the user opts for delivery of the content object during the later timeframe at the lower cost; and
communicating, by the subscriber-side system to the provider-side system over the shared communications link in response to receiving the local request, a remote request indicating that the user opts for delivery of the content object during the later timeframe.

2. The method of claim 1, wherein indicating the prompt providing user selection between delivery of the content object during the earlier timeframe at the higher cost and delivery of the content object during the later timeframe at the lower cost comprises:
receiving, by the subscriber-side system, a content request from the user via the GUI for the content object;
determining that the content object can be provided to the user via the subscriber-side system during at least the earlier timeframe and the later timeframe;
determining the higher cost corresponding to providing the content object to the user at the earlier timeframe and the lower cost corresponding to providing the content object to the user at the later timeframe; and
providing the prompt according to the determined higher cost and the determined lower cost when it is determined that the content object can be provided to the user via the subscriber-side system during at least the earlier timeframe and the later timeframe.

3. The method of claim 1, further comprising:
receiving an opportunistically delayed communication of the content object by the subscriber-side system from the provider-side system in response to the remote request.

4. The method of claim 3, further comprising:
storing the content object in a data store of the subscriber-side system upon receiving the opportunistically delayed communication.

5. The method of claim 3, further comprising:
indicating, to the user via the GUI, receipt of the content object subsequent to receiving the opportunistically delayed communication.

6. The method of claim 1, further comprising:
determining, by the subscriber-side system, whether the object is presently stored in a data store of the subscriber-side system,
wherein the prompt is provided by the subscriber-side system via the GUI only when the content object is not presently stored in a data store of the subscriber-side system.

7. The method of claim 1, wherein:
the subscriber-side system is associated with a subscriber to a media plan having a data allowance policy; and
at least one of the earlier timeframe, the higher cost, the later timeframe, or the lower cost is determined according to the data allowance policy of the subscriber.

8. The method of claim 1, wherein the lower cost comprises at least one of:
a lower price charged for delivery of the at least one content object; a lower cost per bit to deliver the at least one content object; a reduced debit to a usage allowance associated with the data allowance policy of the subscriber; or a reduced impact to resource throttling under the data allowance policy of the subscriber.

9. The method of claim 1, wherein delivery of the content object at the lower cost is delivery of the content object at no cost.

10. The method of claim 1, wherein delivery of the at least one content object during the earlier timeframe is substantially real-time delivery of the at least one content object.

11. The method of claim 1, wherein generating the GUI comprises generating the GUI via a web browser interface or generating the GUI via an electronic program guide interface.

12. A subscriber-side system in communication with a provider-side system via a shared communications link of a communications infrastructure that provides resource sharing of the shared communications link, the subscriber-side system comprising:
a customer premises device operable to:
display a graphical user interface (GUI) to a user through which a plurality of content objects are offered in association with a media plan; and
display a prompt via the GUI that provides user selection between delivery of a content object of the plurality of content objects during a first timeframe at a first cost and delivery of the content object during a second timeframe at a second cost, the first timeframe ending sooner than the second timeframe with respect to a time at which the prompt is displayed, and the first cost being higher than the second cost; and
a subscriber optimizer in communication with the customer premises device and operable to:
determine, in response to a user interaction via the GUI with the content object, to display the prompt as a function of other content objects that are presently scheduled for delivery over the shared communications link in response to requests from other subscriber-side systems sharing the shared communications link;
receive a local request in response to the prompt indicating that the user opts for delivery of the content object during the second timeframe at the second cost; and
communicate to the provider-side system over the communications link, in response to receiving the local request, a remote request indicating that the user opts for delivery of the content object during the second timeframe.

13. The subscriber-side system of claim 12, wherein:
the subscriber optimizer is further operable to:
receive a content request from the user via the customer premises device for the content object;
communicate a query to the provider-side system to determine when the content object can be provided to the user; and
receive an indication from the provider-side system, in response to the query, that the content object can be provided to the user during at least the first timeframe at the first cost and during the second timeframe at the second cost; and
the customer premises device is operable to display the prompt according to the indication received from the provider-side system.

14. The subscriber-side system of claim 12, wherein the subscriber optimizer is further operable to:
receive an opportunistically delayed communication of the content object from the provider-side system in response to the remote request.

15. The subscriber-side system of claim 14, further comprising:
a data store, local to and in communication with the optimizer, and operable to store the content object upon receiving the opportunistically delayed communication.

16. A method for resource shifting in a communications infrastructure that provides sharing of a shared communications link when communicating with a plurality of subscribers via their respective subscriber terminals, the method comprising:
receiving, by a provider-side system of the communications infrastructure, a request for a content object from a requesting subscriber via the communications infrastructure;
determining, with respect to a plurality of pending requests from subscribers other than the requesting subscriber over the shared communications link, whether to offer the requesting subscriber a benefit in exchange for the requesting subscriber opting for delayed delivery of the content object over the shared communications link;
offering the requesting subscriber the benefit in exchange for opting for delayed delivery of the content object according to the determining; and
communicating the content object to the requesting subscriber in an opportunistically delayed manner via the communications infrastructure in response to determining that the requesting subscriber opted for delayed delivery of the content object.

17. The method of claim 16, further comprising:
subsequent to communicating the content object to the requesting subscriber in the opportunistically delayed manner, accounting for delivery of the content object to the requesting subscriber according to the benefit.

18. The method of claim 16, wherein:
the requesting subscriber is a subscriber to a media plan having a data allowance policy under which provision of the content object to the requesting subscriber in a substantially non-delayed manner carries a base accounting impact to the data allowance policy of the requesting subscriber; and
offering the requesting subscriber the benefit comprises offering the requesting subscriber to receive the content object in a delayed timeframe in exchange for a reduced accounting impact to the data allowance policy of the requesting subscriber.

19. The method of claim 18, wherein the benefit is a 100-percent discount.

20. The method of claim 18, wherein:
the data allowance policy comprises a usage allowance;
the base accounting impact to the data allowance policy of the requesting subscriber is a base debit to the usage allowance; and
the reduced accounting impact to the data allowance policy of the requesting subscriber is a smaller debit to the usage cap than that of the base debit.

21. The method of claim 16, further comprising:
determining, by the provider-side system, whether the requesting subscriber opted for delayed delivery of the content object in response to offering the requesting subscriber, via the subscriber terminal of the requesting subscriber, the benefit in exchange opting for delayed delivery of the content object.

22. The method of claim 21, further comprising:
receiving, in association with the request for the content object, a communication from the requesting subscriber indicating that the requesting subscriber opted for delayed delivery of the content object,
wherein the determining whether the requesting subscriber opted for delayed delivery of the content object step is performed according to the communication.

23. The method of claim 22, wherein the communication from the requesting subscriber indicates that the requesting subscriber explicitly opted for delayed delivery of the content object.

24. The method of claim 22, further comprising:
determining whether the content object is a delayable object;
communicating, to a subscriber system of the requesting subscriber when the content object is a delayable object, an indication that the content object is a delayable object; and
receiving, from the subscriber system in response to communicating the indication, the communication from the requesting subscriber indicating that the requesting subscriber opted for delayed delivery of the content object.

25. A provider-side system of a communications infrastructure that provides resource sharing of a shared communications link between the provider-side system and a plurality of subscribers via their respective subscriber terminals, the provider-side system comprising:
a request handling subsystem operable to:
receive a request for a content object from a requesting subscriber via the communications infrastructure;
determine, with respect to a plurality of pending requests from subscribers other than the requesting subscriber over the shared communications link, whether to offer the requesting subscriber a benefit in exchange for the requesting subscriber opting for delayed delivery of the content object over the shared communications link; and
determine whether the requesting subscriber opted for delayed delivery of the content object; and
a communications subsystem, in communication with the request handling subsystem, and operable to:
communicate the offer to the requesting subscriber when determined to do so by the request handling subsystem; and
communicate the content object to the requesting subscriber in an opportunistically delayed manner via the communications infrastructure in response to determining that the requesting subscriber opted for delayed delivery of the content object.

26. The provider-side system of claim 25, further comprising:
an accounting subsystem operable, subsequent to communicating the content object to the requesting subscriber in the opportunistically delayed manner, to account for delivery of the content object to the requesting subscriber according to the benefit.

27. The provider-side system of claim 25, wherein:
the request handling subsystem is further operable to determine according to the request for the content object whether the content object is a delayable object;
the communications subsystem is operable to:
communicate the offer to the requesting subscriber only when the request handling subsystem determines that the content object is a delayable object; and
receive a communication from the requesting subscriber in response to the offer indicating whether the requesting subscriber opted for delayed delivery of the content object; and
the request handling subsystem is operable to determine whether the requesting subscriber opted for delayed delivery of the content object according to the communication received from the requesting subscriber in response to the offer.

28. The method of claim 1, further comprising:
offering delivery of the content object during the earlier timeframe regardless of the determining,
wherein the determining comprises:
calculating whether the content object is deliverable during the later timeframe according to predicted resource availability of the shared communications link during the later timeframe; and
determining to offer delivery of the content object during both the earlier timeframe and the later timeframe only when the content object is deliverable according to the calculating.

29. The method of claim 1, further comprising:
offering delivery of the content object during the later timeframe regardless of the determining,
wherein the determining comprises:
calculating whether the content object is deliverable during the earlier timeframe according to predicted resource availability of the shared communications link during the earlier timeframe; and
determining to offer delivery of the content object during both the earlier timeframe and the later timeframe only when the content object is deliverable according to the calculating.
